(19) United States
(12) Patent Application Publication
(10) Pub. No.: US 2026/0213980 A1
(43) Pub. Date: Jul. 23, 2026

(54) HIGH PERFORMANCE PILOT ASSIGNMENT FOR MASSIVE MULTIPLE INPUT MULTIPLE OUTPUT NETWORKS

(71) Applicant: NOKIA SOLUTIONS AND NETWORKS OY, Espoo (FI)

(72) Inventors: Carles DIAZ VILOR, Irvine, CA (US); Alexei ASHIKHMIN, Morristown, NJ (US); Hong YANG, Ledgewood, NJ (US)

(21) Appl. No.: 19/144,104

(22) PCT Filed: Dec. 28, 2022
(86) PCT No.: PCT/US2022/054122

§ 371 Date: Jun. 27, 2025

(51) Int. Cl. H04L 25/02; H04B 7/0413; H04B 17/336

(52) U.S. Cl. CPC H04L 25/021; H04B 7/0413; H04B 17/336

(57) ABSTRACT

High performance pilot assignment for massive multiple input multiple output networks is provided. The method may include calculating a channel correlation between at least one pair of user equipment. The method may also include executing a greedy algorithm based on the calculated channel correlation to determine one or more pilots that maximize a signal to interference noise ratio of at least one user equipment. The determined one or more pilots may be assigned to the at least one pair of user equipment.

### TECHNICAL FIELD

Some example embodiments may generally relate to mobile or wireless telecommunication systems, such as Long Term Evolution (LTE) or fifth generation (5G) new radio (NR) access technology, or beyond-5G, or other communications systems. For example, certain example embodiments may relate to high performance pilot assignment for massive multiple input multiple output (MIMO) networks.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Various exemplary embodiments may provide an apparatus including at least one processor and at least one memory storing instructions. When executed by the at least one processor, the stored instructions may cause the apparatus at least to calculate a channel correlation between at least one pair of user equipment. A greedy algorithm may be executed based on the calculated channel correlation to determine one or more pilots that maximize a signal to interference noise ratio of at least one user equipment. The apparatus may be further caused to assign the determined one or more pilots to the at least one pair of user equipment.

Various exemplary embodiments may provide a method including calculating a channel correlation between at least one pair of user equipment, and executing a greedy algorithm based on the calculated channel correlation to determine one or more pilots that maximize a signal to interference noise ratio of at least one user equipment. The method may also include assigning the determined one or more pilots to the at least one pair of user equipment.

Some exemplary embodiments may provide an apparatus including a means for calculating a channel correlation between at least one pair of user equipment, and a means for executing a greedy algorithm based on the calculated channel correlation to determine one or more pilots that maximize a signal to interference noise ratio of at least one user equipment. The apparatus may further include a means for assigning the determined one or more pilots to the at least one pair of user equipment.

Certain exemplary embodiments may provide a non-transitory computer readable medium including program instructions. When executed by an apparatus, the program instructions may cause the apparatus at least to calculate a channel correlation between at least one pair of user equipment, and execute a greedy algorithm based on the calculated channel correlation to determine one or more pilots that maximize a signal to interference noise ratio of at least one user equipment. The apparatus may further be caused to assign the determined one or more pilots to the at least one pair of user equipment.

Various exemplary embodiments may provide a computer program including instructions for performing one or more of the methods described herein. Some exemplary embodiments may also provide an apparatus including one or more circuitry configured to perform one or more of the methods described herein.

### BRIEF DESCRIPTION OF THE DRAWINGS

For proper understanding of example embodiments, reference should be made to the accompanying drawings, as follows:

FIG. 1 illustrates an exemplary algorithm in the form of logic code for executing a greedy algorithm for pilot assignment, according the various exemplary embodiments;

FIG. 2 illustrates exemplary algorithms related to a pilot assignment procedure, according to some exemplary embodiments;

FIG. 3 illustrates an exemplary flow diagram of procedures, according to certain exemplary embodiments;

FIG. 4(a) illustrates an example of simulation results comparing a multiple input multiple output (MIMO) network, according to various exemplary embodiments, to a fixed pilot assignment;

FIG. 4(b) illustrates an example of simulation results comparing a MIMO network, according to various exemplary embodiments to a fixed pilot assignment;

FIG. 4(c) illustrates an example of simulation results comparing a MIMO network, according to some exemplary embodiments to a fixed pilot assignment;

FIG. 4(d) illustrates an example of simulation results comparing a MIMO network, according to certain exemplary embodiments to a fixed pilot assignment;

FIG. 5 illustrates an example of a flow diagram of a method, according to various exemplary embodiments; and

FIG. 6 illustrates a configuration of apparatuses, according to certain exemplary embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and non-transitory computer program products for high performance pilot assignment for massive multiple input multiple output (MIMO) networks. For instance, certain exemplary embodiments may be directed to optimizing signal to interference and noise ratio (SINR) metrics using high performance pilot assignment for massive MIMO applications.

Massive MIMO networks may be implemented by a radio access network (RAN) and may be formed of a plurality of antenna arrays at a base station that serve a large number of users via associated user equipment using the same time-frequency resources. Massive MIMO networks use a multipath effect to obtain diversity and multiplexing gain, which increase the link rate and reduce the bit error rate. The MIMO network may be formed by channels between the antennas of the base station and the multiple user equipment communicating with the antennas of the base station. To establish communication, the channel may be estimated using signals, which are also referred to as pilots, that use known information and a channel coefficient to form a channel.

Beamforming in the MIMO network may rely on accurate channel state information (CSI), which may be acquired via uplink pilots. Orthogonal pilots that may be assigned to different user equipment (UE) may not cause interference, or minimal interference, in the data transmission as compared to using non-orthogonal pilots. Non-orthogonal pilots and pilot reuse by different UE may result in pilot contamination that can severely compromise the quality of CSI estimation. The capacity of massive MIMO systems may also be restricted or constrained by pilot contamination.

Pilot contamination may occur when two or more equipment are assigned to the same pilot or non-orthogonal pilot. Under traditional cellular MIMO networks, a set of orthogonal pilots in one cell may reach antennas of a base station of a neighboring cell and interfere with the pilots of that neighboring base station. A signal arriving at a base station is a linear combination of pilots from one user equipment in the same cell and another user equipment in the neighboring cell. All the pilots that are not completely orthogonal to the other pilot may cause interference in the uplink during training stage and in the downlink during the data transmission stage. For beyond-5G networks, a distributed MIMO (D-MIMO) topology may be suitable, where (a) the concept of cell is removed, (b) a given UE establishes connectivity to multiple access points (APs), and (c) the concept of interference is redefined. Pilot contamination may occur when two or more UEs use the same pilot or nonorthogonal pilot(s) and are served by a set of common APs, which may cause a degradation in the experienced SINR as in the cellular case.

For the duration of a channel estimation process, the coherence time may be limited. The coherence time may be a time interval within which the system can acquire CSI to estimate the channel/pilot. The CSI may be computed based on pilots used during transmission and then matched with the received pilot signals.

A cellular MIMO network may be considered a special use case of a D-MIMO network. For example, in cellular MIMO networks, orthogonal pilots may be used in a current cell and reused in adjacent cells, while in D-MIMO networks, UEs may reuse a set of orthogonal pilots or use non-orthogonal pilots. The base station may estimate the channel of user equipment in its cell while a user equipment in another cell communicates the same pilot signal, which causes interference. The channel estimate acquired from such cells may be corrupted by estimates from nearby cells causing the pilot contamination. A similar effect may occur in D-MIMO networks where multiple UEs either reuse orthogonal pilots or use non-orthogonal pilots and are served by a set of common base stations.

A metric of interest may be, for example, a signal to interference and noise ratio (SINR), which may be a quality measurement in an NR network. SINR may be the relative difference between a signal power of a received wireless signal and noise and interference values. During pilot assignment, various exemplary embodiments discussed herein aim to optimize the minimum SINR of the network, which may minimize the pilot contamination and increase a per UE data throughput of the network.

While efforts may have been made on improving pilot assignment in cellular networks, D-MIMO poses challenges given that APs are distributed throughout a region. As a consequence, such a distribution may be taken into account when assigning pilot sequences and combined with network scalability, i.e., a subset of APs, may be providing service to a subset of UEs.

Various exemplary embodiments may provide several technical improvements, enhancements, and/or advantages including, for example, providing low-complexity procedures that results in an improvement of the minimum SINR. Some exemplary embodiments may provide more accurate approximations for the SINR in D-MIMO networks that depend on large scale parameters and therefore may be the same for all orthogonal frequency division multiplexing (OFDM) tones and changes slowly in time, which reduces the complexity of the pilot assignment algorithm. Certain exemplary embodiments may further provide greedy codebook assignment for optimizing SINR.

Various exemplary embodiments may provide procedures for performing an initial correlation-based pilot assignment to perform channel estimation of the network. The correlation-based pilot assignment may be performed for a set of orthogonal pilots with a certain pilot reuse factor, which may be performed at least by computing an overall channel correlation between pairs of UEs of users and assigning corresponding pilots such that UEs with minimum correlation use the same pilot. A greedy algorithm may then be executed on the correlation-based pilot assignment to optimize the pilot assignment.

An exemplary D-MIMO network may be formed of one or more APs, which have a number value of M, and each of the APs may have a corresponding number N of antennas and/or L radio frequency chains when the transceivers have hybrid beamforming capabilities. The number N of antennas and L radio frequency chains may be referred to interchangeably depending on the applicable situation. The exemplary D-MIMO network may also include one or more UEs, which may have a number value of K, and a channel covariance matrix between AP ‘m’ and UE ‘k’ is: R_{m,k}. Each pair may have a channel covariance matrix. Each UE k may establish connectivity to a subset of APs, which may be defined by equation (1) as follows:

$${a}_{m , k} = 1 \{ m ∈ {F}_{k} \} . \qquad ( 1 )$$

Where a_{m,k} may indicate whether APₘ serves UEₖ, and Fₖ may be the subset of APs providing service to UE k, 1{ } is the indicator function. This algorithm may be referred to as the AP connectivity equation. The UE-AP connectivity may be based on a distance between the UE and the AP. For example, if the distance between UE k and AP m is greater than X meters, then, for example, a_{m,k}=0, and if not, for example, a_{m,k}=1.

Using the AP connectivity equation defined above, a correlation metric for each pair of UEs may be calculated using equation (2) as follows:

$${Σ}_{m = 1}^{M} {a}_{m , k} {a}_{m , j} trace ( {R}_{m , k} {R}_{m , j} ) \qquad ( 2 )$$

Equation (2) may be performed in one or more iterations, and/or may be executed as a greedy algorithm to optimize the correlation determination. The equation (2) may be implemented as a greedy algorithm by using orthogonal pilots. In some exemplary embodiments, when orthogonal pilots are used for determining correlation, the pilots assigned as a result of equation (2) are applied to the network and further optimization may not occur. In certain exemplary embodiments, the pilots assigned as a result of equation (2) may be further optimized to provide a more optimal solution, as discussed below.

If the calculated correlation metric is comparatively small/low, the pair of UEs may have uncorrelated channels. If the calculated correlation metric is comparatively large/high, the pair of UEs may have correlated channels. The same pilot may be iteratively assigned to UEs of pairs with a small/low correlation based on the calculated correlation metric. This may be referred to as correlation-based assignment.

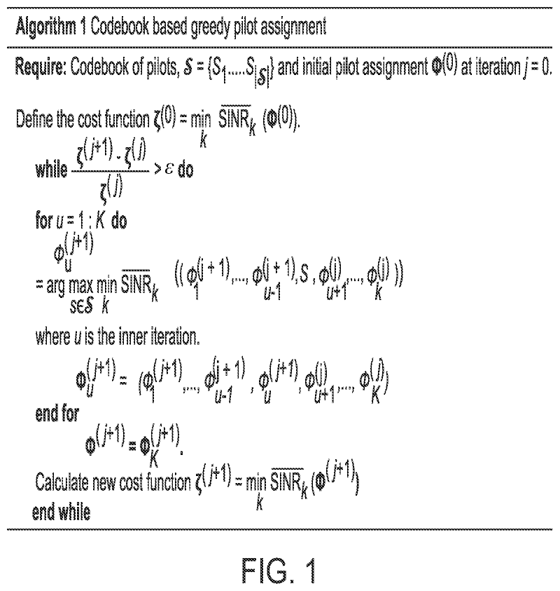

Once a pilot is assigned to each UE using the correlation-based assignment, a greedy algorithm may be executed based on SINR approximations. FIG. 1 illustrates an exemplary algorithm (Algorithm 1) in the form of logic code for executing the greedy algorithm for pilot assignment, according to the various exemplary embodiments. The greedy algorithm may be based on first and second SINR approximations to be iteratively performed to optimize and/or maximize the minimum network SINR, as discussed in more detail below. The greedy algorithm may follow a problem-solving heuristic of making a locally optimal choice at each stage, such that SINR of the network is optimized. The greedy heuristic may yield locally optimal solutions that approximate a globally optimal solution in a reasonable amount of time. The greedy algorithm (Algorithm 1) may be a codebook based on the greedy pilot assignment, which may be formed of a codebook of pilots {s₁ . . . , s_{|S|}} and an initial pilot assignment Φ⁽⁰⁾ at iteration j=0. The initial pilot assignment Φ⁽⁰⁾ may be, for example, set as the result of the correlation-based assignment according to equation (2). The codebook of pilots may be composed by 5G NR sequences, such as, for example, Gold sequence, Zadoff-Chu sequence, m-sequence, and the like.

In certain exemplary embodiments, the Algorithm 1 shown in FIG. 1 is a greedy algorithm and may be iteratively performed until a convergence is achieved, which may be defined by a stopping criterion

$$\frac{{ζ}^{( j + 1 )} - {ζ}^{( j )}}{{ζ}^{( j )}} \leq ε .$$

Here j may be the iteration counter, ζ may be the minimum SINR among K active users, and ε may be a pre-determined stopping threshold for the relative level of improvement of the minimum SINR from one iteration to the next iteration. The cost function may be defined as

$${ζ}^{( 0 )} = {min}_{k} {\overline{SINR}}_{k} ( {Φ}^{( 0 )} ) .$$

For example, the stopping criterion may be set as ε=5%. In this example, the iteration may stop when the minimum SINR improvement is less than 5%.

Another iteration stopping criterion may be a fixed maximum number of iterations, which may be based on the system computation capability. For example, a maximum number of iterations may be set as 10 iterations. In some exemplary embodiments, stopping criterions may also be combined. For example, iterations may stop when the specified maximum number of iterations is reached or when the minimum SINR improvement is less than a specific level. Once convergence occurs, a new pilot assignment for the UEs may be obtained, which may optimize the SINR of the network and reduce the impact of interference and pilot contamination.

A first SINR approximation may be determined for uplink (UL) under minimum mean-square-error (MMSE) reception. The first SINR approximation may be based on equation (3) as follows:

$$\overline{{SINR}_{k}} = \frac{{p}_{k}}{\vert {F}_{k} \vert L} {\sum }_{m ∈ {F}_{k}} tr [ {Γ}_{m , k}^{( ℊ )} {T}_{m , k} ] \qquad ( 3 )$$

Where SINRₖ may indicate an SINR of the UE k, pₖ may be a transmit power of the kth UE, Fₖ may be the subset of APs providing service to UE k, L may indicate the number of antennas per AP (or radio frequency (RF) chains for hybrid beamforming), tr may refer to an algebraic trace operator, and

$${Γ}_{m , k}^{( ℊ )}$$

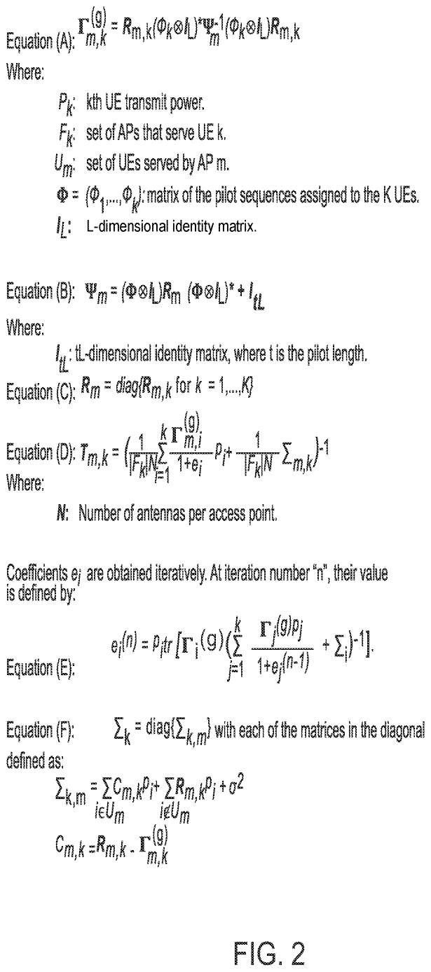

and T_{m,k} represent an estimate of the spatial correlation matrix and the MMSE whitening matrix, respectively, and may be defined as shown in FIG. 2.

A second SINR approximation may be determined for downlink (DL) under regularized zero forcing (RZF) precoding. The second SINR approximation may be based on equation (4) as follows:

$$\overline{{SINR}_{k}} = \frac{\frac{{μ}_{k}^{2}}{{δ}_{k}} {p}_{k}}{{Σ}_{i \neq 1}^{K} \frac{{θ}_{k , i}}{{δ}_{i}} {p}_{i} + {σ}^{2}} \qquad ( 4 )$$

Where SINRₖ may indicate an SINR of the UE k, pᵢ may be the transmit power towards the ith UE, the ratio

$$\frac{μ k}{{δ}_{k}}$$

may be an estimate of the received signal power from UE k, the ratio

$$\frac{{θ}_{k , i}}{{δ}_{i}}$$

may be an estimate of the interference that UE i is causing to UE k, and σ may be a noise standard deviation.

The first and second SINR approximations may be based on large scale parameters, such as, for example, channel covariance matrices, which are stationary under small scale fading variations. Small scale variations may be a random variable used to reflect scattering in the environment. The first and second SINR approximations may be accurate approximations for any set of pilots, such as, for example, 3GPP, orthogonal, random, and the like. FIG. 2 illustrates exemplary algorithms related to the pilot assignment and SINR approximations procedure of FIG. 1, according to some exemplary embodiments.

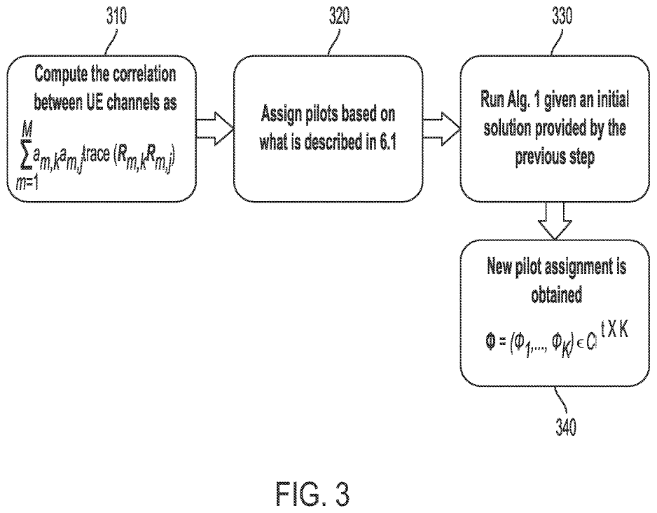

FIG. 3 illustrates flow diagram of procedures according to certain exemplary embodiments. At 310, the D-MIMO network layer may compute a correlation between UE channels. At 320, pilots may be assigned based on the correlation-based assignment described herein. At 330, the greedy algorithm (Algorithm 1) may be executed based on the SINR approximations that initially assign pilots to the UEs according to 320. At 340, the output of the greedy algorithm (Algorithm 1) may provide an optimal solution for SINR for the network and a new pilot assignment is performed based on the solution.

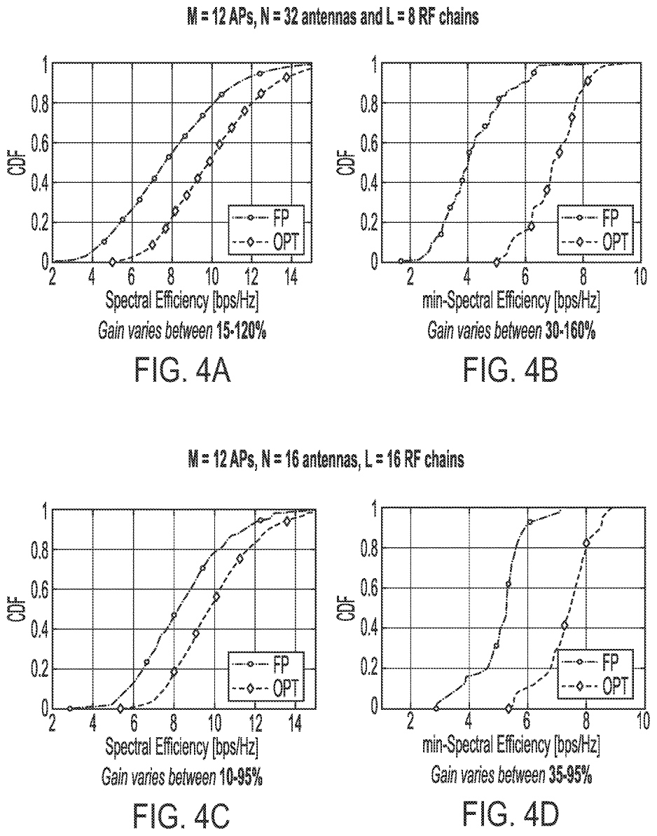

FIGS. 4(a)-4(d) illustrate examples of experimental results comparing the D-MIMO network, according to various exemplary embodiments, which is labeled as OPT in FIGS. 4(a)-4(d), with respect to a fixed pilot assignment (FP). The fixed pilot assignment may be a randomized assignment of pilots. FIGS. 4(a)-4(d) illustrate examples in which a D-MIMO network may be formed of M=12 APs, each with N=16 antennas or 32 antennas. A length of the pilot sequences may be set to τ=8, and a pilot reuse factor may be two (2) given that the number of UEs is K=16. A cumulative density function (CDF) over all UE spectral efficiencies and over the minimum one under UL-MMSE reception may be measured. FIGS. 4(a)-4(d) illustrate examples of the overall D-MIMO network (left side graphs) and examples of a subset of UEs with minimum spectral efficiency (right side graphs).

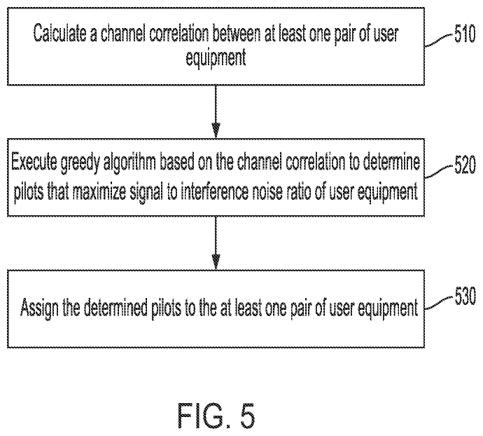

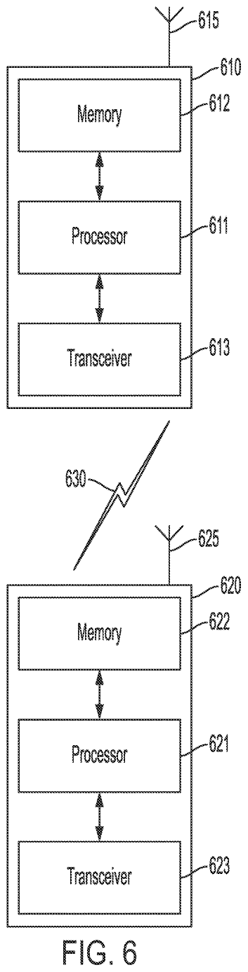

FIG. 5 illustrates an example flow diagram of a method, according to various exemplary embodiments. In the exemplary embodiments, the method of FIG. 5 may be performed by a network element, or a group of multiple network elements in a 3GPP system, such as LTE or 5G-NR. For instance, in the exemplary embodiments, the method of FIG. 4 may be performed by a network entity (NE) similar to apparatus 610 illustrated in FIG. 6.

According to various exemplary embodiments, the method of FIG. 5 may include, at 510, calculating a channel correlation between at least one pair of user equipment, which may be similar to apparatus 620. At 520, a greedy algorithm may be executed based on the calculated channel correlation to determine one or more pilots that maximize a signal to interference noise ratio of at least one user equipment, and at 530, the determined one or more pilots may be assigned to the at least one pair of user equipment.

According to various exemplary embodiments, the method of FIG. 5 may further include performing a correlation-based assignment using the greedy algorithm to assign initial pilots to the pair of user equipment. The initial pilots may be assigned such that identical or substantially identical pilots are assigned to user equipment having a lowest calculated channel correlation. The greedy algorithm may be executed using the initial pilots and iteratively performing the greedy algorithm to determine the one or more pilots that maximize the signal to interference noise ratio.

According to some exemplary embodiments, the method of FIG. 5 may further include calculating a first approximation of the signal to interference noise ratio to be used by the greedy algorithm to determine the one or more pilots that maximize the signal to interference noise ratio. The first approximation may be calculated using equation (3) above. The first approximation may be determined for uplink under a minimum mean-square-error reception.

According to certain exemplary embodiments, the method of FIG. 5 may further include calculating a second approximation of the signal to interference noise ratio to be used by the greedy algorithm to determine the one or more pilots that maximize the signal to interference noise ratio. The second approximation may be calculated using equation (4) above. The second approximation may be determined for downlink under regularized zero forcing precoding.

According to some exemplary embodiments, the channel correlation for the at least one pair of user equipment may be calculated using equation (2) above.

FIG. 6 illustrates a set of apparatuses 610 and 620 according to various exemplary embodiments. In the various exemplary embodiments, the apparatus 610 may be a network, RAN element, or element in a communications network or associated with such a network, such as a base station, an NE, or a gNB. It should be noted that one of ordinary skill in the art would understand that apparatus 610 may include components or features not shown in FIG. 6. In addition, apparatus 620 may be an element in a communications network or associated with such a network, such as a UE, RedCap UE, SL UE, mobile equipment (ME), mobile station, mobile device, stationary device, IoT device, or other device. It should be noted that one of ordinary skill in the art would understand that apparatus 620 may include components or features not shown in FIG. 6.

According to various exemplary embodiments, the apparatus 610 may include at least one processor 611, and at least one memory 612, as shown in FIG. 6. The memory 612 may store instructions that, when executed by the processor 611, cause the apparatus 610 to perform the method as discussed above with respect to FIG. 5.

According to various exemplary embodiments, the apparatus 620 may include at least one processor 621, and at least one memory 622, as shown in FIG. 6. The memory 622 may store instructions that, when executed by the processor 621, cause the apparatus 620 to perform certain procedures discussed herein.

For example, the apparatus 620 may be caused to calculate a channel correlation between at least one pair of user equipment. The apparatus may be further caused to execute a greedy algorithm based on the calculated channel correlation to determine one or more pilots that maximize a signal to interference noise ratio of at least one user equipment. The apparatus may be further caused to assign the determined one or more pilots to the at least one pair of user equipment.

In some example embodiments, an apparatus (for example, apparatuses 610 and/or 620) may include means for performing a method, a process, or any of the variants discussed herein. Examples of the means may include one or more processors, memory, controllers, transmitters, receivers, and/or computer program code for causing the performance of the operations.

According to some exemplary embodiments, the apparatus (for example, apparatuses 610) may include at least one processor and at least one memory. The memory may store instructions that, when executed by the at least one processor, cause the apparatus at least to calculate a channel correlation between at least one pair of user equipment, and execute a greedy algorithm based on the calculated channel algorithm to determine a pilot that maximizes a signal to interference noise ratio. The apparatus may also be caused to assign the determined pilot to the at least one pair of user equipment.

Various exemplary embodiments described above may provide several technical improvements, enhancements, and/or advantages. For instance, in some exemplary embodiments, it may be possible to enhance the performance of the network by providing low-complexity procedures that result in an improvement of the minimum SINR of the network. Some exemplary embodiments may provide more accurate approximations for the SINR in D-MIMO networks that depend on large scale parameters and therefore may be the same for all orthogonal frequency division multiplexing (OFDM) tones and changes slowly in time, which reduces the complexity of the pilot assignment algorithm.

In some example embodiments, apparatuses 610 and/or 620 may include one or more processors, one or more computer-readable storage medium (for example, memory, storage, or the like), one or more radio access components (for example, a modem, a transceiver, or the like), and/or a user interface. In some example embodiments, apparatuses 610 and/or 620 may be configured to operate using one or more radio access technologies, such as GSM, LTE, LTE-A, NR, 5G, WLAN, WiFi, NB-IoT, Bluetooth, NFC, MulteFire, and/or any other radio access technologies.

As illustrated in the example of FIG. 6, apparatuses 610 and/or 620 may include or be coupled to processors 611 and 621, respectively, for processing information and executing instructions or operations. Processors 611 and 621 may be any type of general or specific purpose processor. In fact, processors 611 and 621 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 611 (and 621) for each of apparatuses 610 and/or 620 is shown in FIG. 6, multiple processors may be utilized according to other example embodiments. For example, it should be understood that, in certain example embodiments, apparatuses 610 and/or 620 may include two or more processors that may form a multiprocessor system (for example, in this case processors 611 and 621 may represent a multiprocessor) that may support multiprocessing. According to certain example embodiments, the multiprocessor system may be tightly coupled or loosely coupled to, for example, form a computer cluster.

Processors 611 and 621 may perform functions associated with the operation of apparatuses 610 and/or 620, respectively, including, as some examples, precoding of antenna gain/phase parameters, encoding and decoding of individual bits forming a communication message, formatting of information, and overall control of the apparatuses 610 and/or 620, including processes illustrated in FIGS. 1, 3, and 5.

Apparatuses 610 and/or 620 may further include or be coupled to memory 612 and/or 622 (internal or external), respectively, which may be coupled to processors 611 and 621, respectively, for storing information and instructions that may be executed by processors 611 and 621. Memory 612 (and memory 622) may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 612 (and memory 622) can be comprised of any combination of random access memory (RAM), read only memory (ROM), static storage such as a magnetic or optical disk, hard disk drive (HDD), or any other type of non-transitory machine or computer readable media. The instructions stored in memory 612 and memory 622 may include program instructions or computer program code that, when executed by processors 611 and 621, enable the apparatuses 610 and/or 620 to perform tasks as described herein.

In certain example embodiments, apparatuses 610 and/or 620 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 611 and 621 and/or apparatuses 610 and/or 620 to perform any of the methods illustrated in FIGS. 1, 3, and 5.

In some exemplary embodiments, apparatuses 610 and/or 620 may also include or be coupled to one or more antennas 615 and 625, respectively, for receiving a downlink signal and for transmitting via an uplink from apparatuses 610 and/or 620. Apparatuses 610 and/or 620 may further include transceivers 613 and 623, respectively, configured to transmit and receive information. The transceivers 613 and 623 may also include a radio interface (for example, a modem) respectively coupled to the antennas 615 and 625. The radio interface may correspond to a plurality of radio access technologies including one or more of GSM, LTE, LTE-A, 5G, NR, WLAN, NB-IoT, Bluetooth, BT-LE, NFC, RFID, UWB, or the like. The radio interface may include other components, such as filters, converters (for example, digital-to-analog converters or the like), symbol demappers, signal shaping components, an Inverse Fast Fourier Transform (IFFT) module, or the like, to process symbols, such as OFDMA symbols, carried by a downlink or an uplink.

For instance, transceivers 613 and 623 may be respectively configured to modulate information on to a carrier waveform for transmission by the antenna(s) 615 and 625, and demodulate information received via the antenna(s) 615 and 625 for further processing by other elements of apparatuses 610 and/or 620. In other example embodiments, transceivers 613 and 623 may be capable of transmitting and receiving signals or data directly. Additionally or alternatively, in some example embodiments, apparatuses 610 and/or 620 may include an input and/or output device (I/O device). In certain example embodiments, apparatuses 610 and/or 620 may further include a user interface, such as a graphical user interface or touchscreen.

In certain example embodiments, memory 612 and memory 622 store software modules that provide functionality when executed by processors 611 and 621, respectively. The modules may include, for example, an operating system that provides operating system functionality for apparatuses 610 and/or 620. The memory may also store one or more functional modules, such as an application or program, to provide additional functionality for apparatuses 610 and/or 620. The components of apparatuses 610 and/or 620 may be implemented in hardware, or as any suitable combination of hardware and software. According to certain example embodiments, apparatus 610 may optionally be configured to communicate with apparatus 620 via a wireless or wired communications link 630 according to any radio access technology, such as NR.

According to certain example embodiments, processors 611 and 621, and memory 612 and 622 may be included in or may form a part of processing circuitry or control circuitry. In addition, in some example embodiments, transceivers 613 and 623 may be included in or may form a part of transceiving circuitry.

As used herein, the term “circuitry” may refer to hardware-only circuitry implementations (for example, analog and/or digital circuitry), combinations of hardware circuits and software, combinations of analog and/or digital hardware circuits with software/firmware, any portions of hardware processor(s) with software, including digital signal processors, that work together to cause an apparatus (for example, apparatus 610 and/or 620) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor or multiple processors, or portion of a hardware circuit or processor, and the accompanying software and/or firmware. The term circuitry may also cover, for example, a baseband integrated circuit in a server, cellular network node or device, or other computing or network device.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (for example, apparatuses 610 and/or 620), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
AP Access Point
CSI Channel State Information
DL Downlink
EMBB Enhanced Mobile Broadband
gNB 5G or Next Generation NodeB
LTE Long Term Evolution
MIMO Multiple Input Multiple Output
D-MIMO Distributed MIMO
mMIMO Massive MIMO
MMSE Minimum Mean-Square-Error
NR New Radio
NE Network Entity
OFDM Orthogonal Frequency Division Multiplexing
RAN Radio Access Network
RZF Regularized Zero Forcing
SINR Signal to Interference and Noise Ratio
UE User Equipment
UL Uplink

1. An apparatus, comprising:
at least one processor; and
at least one memory storing instructions that, when executed by the at least one processor, cause the apparatus at least to:
calculate a channel correlation between at least one pair of user equipment;
execute a greedy algorithm based on the calculated channel correlation to determine one or more pilots that maximize a signal to interference noise ratio of at least one user equipment; and
assign the determined one or more pilots to the at least one pair of user equipment
wherein the channel correlation for the at least one pair of user equipment is calculated according to the following:
$${Σ}_{m = 1}^{M} {a}_{m , k} {a}_{m , j} trace ( {R}_{m , k} {R}_{m , j} ) .$$
where a indicates the access point that serves the respective user equipment, and R is a corresponding channel covariance matrix.

2. The apparatus according to claim 1, wherein the apparatus is further caused to:
perform a correlation-based assignment using the greedy algorithm to assign initial pilots to the pair of user equipment,
wherein the initial pilots are assigned such that identical or substantially identical pilots are assigned to user equipment having a lowest calculated channel correlation, and
wherein the greedy algorithm is executed using the initial pilots and iteratively performing the greedy algorithm to determine the one or more pilots that maximize the signal to interference noise ratio.

3. The apparatus according to claim 1, wherein the apparatus is further caused to:
calculate a first approximation of the signal to interference noise ratio to be used by the greedy algorithm to determine the one or more pilots that maximize the signal to interference noise ratio, wherein the first approximation is calculated according to the following:
$$\overline{{SINR}_{k}} = \frac{{p}_{k}}{\vert {F}_{k} \vert L} {\sum }_{m ∈ {F}_{k}} tr [ {Γ}_{m , k}^{( ℊ )} {T}_{m , k} ]$$
where SINRₖ indicates the signal to interference noise ratio of the at least one user equipment, pₖ is a transmit power of the at least one user equipment, Fₖ is a subset of access points providing service to the at least one user equipment, L indicates the number of antennas per access point or the number of radio frequency (RF) chains for hybrid beamforming per access point, tr is an algebraic trace operator, and rink and
$${Γ}_{{m}_{,} k}^{( ℊ )}$$
and T_{m,k} represent an estimate of the spatial correlation matrix and a minimum mean-square-error whitening matrix, respectively.

4. The apparatus according to claim 3, wherein the first approximation is determined for uplink under a minimum mean-square-error reception.

5. The apparatus according to claim 1, wherein the apparatus is further caused to:
calculate a second approximation of the signal to interference noise ratio to be used by the greedy algorithm to determine the one or more pilots that maximize the signal to interference noise ratio, wherein the second approximation is calculated according to the following:
$$\overline{S I N {R}_{k}} = \frac{\frac{{μ}_{k}^{2}}{{δ}_{k}} {p}_{k}}{{\sum }_{i \neq 1}^{K} \frac{{θ}_{k , i}}{{δ}_{i}} {p}_{i} + {σ}^{2}} .$$
where SINRₖ indicates the signal to interference noise ratio of the at least one user equipment, pₖ is a transmit power of the at least one user equipment, pᵢ is the transmit power towards an ith user equipment, the ratio
$$\frac{{μ}_{k}}{{δ}_{k}}$$
is an estimate of a received signal power from the at least one user equipment, the ratio
$$\frac{{θ}_{k , i}}{{δ}_{i}}$$
is an estimate of an interference that the ith user equipment is causing to the at least one user equipment, and σ is a noise standard deviation.

6. The apparatus according to claim 5, wherein the second approximation is determined for downlink under regularized zero forcing precoding.

7. (canceled)

8. A method, comprising:
calculating a channel correlation between at least one pair of user equipment;
executing a greedy algorithm based on the calculated channel correlation to determine one or more pilots that maximize a signal to interference noise ratio of at least one user equipment; and
assigning the determined one or more pilots to the at least one pair of user equipment
wherein the channel correlation for the at least one pair of user equipment is calculated according to the following:
$${\sum }_{m = 1}^{M} {a}_{m , k} {a}_{m , j} trace ( {R}_{m , k} {R}_{m , j} ) \underline{.}$$
where a indicates the access point that serves the respective user equipment, and R is a corresponding channel covariance matrix.

9. The method according to claim 8, further comprising:
performing a correlation-based assignment using the greedy algorithm to assign initial pilots to the pair of user equipment,
wherein the initial pilots are assigned such that identical or substantially identical pilots are assigned to user equipment having a lowest calculated channel correlation, and
wherein the greedy algorithm is executed using the initial pilots and iteratively performing the greedy algorithm to determine the one or more pilots that maximize the signal to interference noise ratio.

10. The method according to claim 8, further comprising:
calculating a first approximation of the signal to interference noise ratio to be used by the greedy algorithm to determine the one or more pilots that maximize the signal to interference noise ratio, wherein the first approximation is calculated according to the following:
$$\overline{S I N {R}_{k}} = \frac{{p}_{k}}{\vert {F}_{k} \vert L} {\sum }_{m ∈ {F}_{k}} tr [ {Γ}_{m , k}^{( g )} {T}_{m , k} ]$$
where SINRₖ indicates the signal to interference noise ratio of the at least one user equipment, pₖ is a transmit power of the at least one user equipment, Fₖ is a subset of access points providing service to the at least one user equipment, L indicates the number of antennas per access point or the number of radio frequency (RF) chains for hybrid beamforming per access point, tr is an algebraic trace operator, and
$${Γ}_{m , k}^{( g )}$$
and T_{m,k} represent an estimate of the spatial correlation matrix and a minimum mean-square-error whitening matrix, respectively.

11. The method according to claim 10, wherein the first approximation is determined for uplink under a minimum mean-square-error reception.

12. The method according to claim 8, further comprising:
calculating a second approximation of the signal to interference noise ratio to be used by the greedy algorithm to determine the one or more pilots that maximize the signal to interference noise ratio, wherein the second approximation is calculated according to the following:
$$\overline{S I N {R}_{k}} = \frac{\frac{{μ}_{k}^{2}}{{δ}_{k}} {p}_{k}}{{\sum }_{i \neq 1}^{K} \frac{{θ}_{k , i}}{{δ}_{i}} {p}_{i} + {σ}^{2}} .$$
where SINRₖ indicates the signal to interference noise ratio of the at least one user equipment, pₖ is a transmit power of the at least one user equipment, pᵢ is the transmit power towards an ith user equipment, the ratio
$$\frac{{μ}_{k}}{{δ}_{k}}$$
is an estimate of a received signal power from the at least one user equipment, the ratio
$$\frac{{θ}_{k , i}}{{δ}_{i}}$$
is an estimate of an interference that the ith user equipment is causing to the at least one user equipment, and σ is a noise standard deviation.

13. The method according to claim 12, wherein the second approximation is determined for downlink under regularized zero forcing precoding.

14.-21. (canceled)

22. A non-transitory computer readable medium comprising program instructions that, when executed by an apparatus, cause the apparatus at least to:
calculate a channel correlation between at least one pair of user equipment;
execute a greedy algorithm based on the calculated channel correlation to determine one or more pilots that maximize a signal to interference noise ratio of at least one user equipment; and
assign the determined one or more pilots to the at least one pair of user equipment
wherein the channel correlation for the at least one pair of user equipment is calculated according to the following:
$${\sum }_{m = 1}^{M} {a}_{m , k} {a}_{m , j} trace ( {R}_{m , k} {R}_{m , j} ) \underline{.}$$
where a indicates the access point that serves the respective user equipment, and R is a corresponding channel covariance matrix.

23. The non-transitory computer readable medium according to claim 22, wherein the apparatus is further caused to:
perform a correlation-based assignment using the greedy algorithm to assign initial pilots to the pair of user equipment,
wherein the initial pilots are assigned such that identical or substantially identical pilots are assigned to user equipment having a lowest calculated channel correlation, and
wherein the greedy algorithm is executed using the initial pilots and iteratively performing the greedy algorithm to determine the one or more pilots that maximize the signal to interference noise ratio.

24. The non-transitory computer readable medium according to claim 22, wherein the apparatus is further caused to:
calculate a first approximation of the signal to interference noise ratio to be used by the greedy algorithm to determine the one or more pilots that maximize the signal to interference noise ratio, wherein the first approximation is calculated according to the following:
$$\overline{S I N {R}_{k}} = \frac{{p}_{k}}{\vert {F}_{k} \vert L} {\sum }_{m ∈ {F}_{k}} tr [ {Γ}_{m , k}^{( g )} {T}_{m , k} ]$$
where SINRₖ indicates the signal to interference noise ratio of the at least one user equipment, pₖ is a transmit power of the at least one user equipment, Fₖ is a subset of access points providing service to the at least one user equipment, L indicates the number of antennas per access point or the number of radio frequency (RF) chains for hybrid beamforming per access point, tr is an algebraic trace operator, and
$${Γ}_{m , k}^{( g )}$$
and T_{m,k} represent an estimate of the spatial correlation matrix and a minimum mean-square-error whitening matrix, respectively.

25. The non-transitory computer readable medium according to claim 24, wherein the first approximation is determined for uplink under a minimum mean-square-error reception.

26. The non-transitory computer readable medium according to claim 22, wherein the apparatus is further caused to:
calculate a second approximation of the signal to interference noise ratio to be used by the greedy algorithm to determine the one or more pilots that maximize the signal to interference noise ratio, wherein the second approximation is calculated according to the following:
$$\overline{S I N {R}_{k}} = \frac{\frac{{μ}_{k}^{2}}{{δ}_{k}} {p}_{k}}{{\sum }_{i \neq 1}^{K} \frac{{θ}_{k , i}}{{δ}_{i}} {p}_{i} + {σ}^{2}} .$$
where SINRₖ indicates the signal to interference noise ratio of the at least one user equipment, pₖ is a transmit power of the at least one user equipment, pᵢ is the transmit power towards an ith user equipment, the ratio
$$\frac{{μ}_{k}}{{δ}_{k}}$$
is an estimate of a received signal power from the at least one user equipment, the ratio
$$\frac{{θ}_{k , i}}{{δ}_{i}}$$
is an estimate of an interference that the ith user equipment is causing to the at least one user equipment, and σ is a noise standard deviation.

27. The non-transitory computer readable medium according to claim 26, wherein the second approximation is determined for downlink under regularized zero forcing precoding.

28.-30. (canceled)
